(19) United States
(12) Patent Application Publication
(10) Pub. No.: US 2022/0383260 A1
(43) Pub. Date: Dec. 1, 2022

(54) METHOD AND SYSTEM FOR VIRTUAL ASSISTANT DECISION MAPPING AND PRIORITIZATION

(71) Applicant: AT&T Intellectual Property I, L.P., Atlanta, GA (US)

(72) Inventors: Rashmi Palamadai, Naperville, IL (US); Eric Zavesky, Austin, TX (US); Nigel Bradley, Canton, GA (US)

(73) Assignee: AT&T Intellectual Property I, L.P., Atlanta, GA (US)

(21) Appl. No.: 17/335,252

(22) Filed: Jun. 1, 2021

(51) Int. Cl. G06Q 10/10; G06F 3/01; G06F 3/16; H04L 29/08

(52) U.S. Cl. CPC G06Q 10/109; G06F 3/017; G06F 3/167; H04L 67/306

(57) ABSTRACT

Aspects of the subject disclosure may include, for example, obtaining information relating to a context associated with a user, monitoring, based on the obtaining the information, a behavior of the user relative to the context, determining to provide assistance to the user based on the monitoring the behavior of the user, responsive to the determining to provide assistance to the user, identifying an assistive action, wherein the identifying the assistive action is based on a predefined threshold, and based on the identifying the assistive action, performing the assistive action for the user. Other embodiments are disclosed.

### FIELD OF THE DISCLOSURE

The subject disclosure relates to virtual assistant decision mapping and prioritization.

### BACKGROUND

As society continues to modernize and the pace of life accelerates, it is not uncommon for one to pack their schedule from beginning to end with work/personal tasks and engagements with professional contacts, family, and friends in various settings throughout the day.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within, or operatively overlaid upon, the communications network of FIG. 1 in accordance with various aspects described herein.

FIG. 2B is a block diagram illustrating an example, non-limiting embodiment of a system functioning within, or operatively overlaid upon, the communications network of FIG. 1 in accordance with various aspects described herein.

FIG. 2C is a diagram illustrating example, non-limiting scenarios in which one or more of the systems of FIG. 2A and FIG. 2B provide assistance to a user in accordance with various aspects described herein.

FIG. 2D depicts an illustrative embodiment of a method in accordance with various aspects described herein.

FIG. 2E depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

Oftentimes during a busy day, a user may encounter situations where numerous low-priority (or low-consequence) decisions need to be made, and where various options may be available to choose from. In many cases, the user may be distracted or stressed, or may be occupied with higher-priority decisions, and thus may be unable to tend to lower-priority ones.

The subject disclosure describes, among other things, illustrative embodiments of a virtual assistant (VA) platform that is capable of providing assistance to a user, such as with lower priority (or lower impact/consequence) decisions. In exemplary embodiments, the VA platform is capable of identifying, learning, mapping, and/or proposing (e.g., via a suggestion and choice mapping system based on machine learning, conditional mapping and/or other mapping techniques, and/or the like) reduced sets of decisions/feedback for a user.

In various embodiments, the VA platform may be configured to monitor the behavior of a user and/or contextual (or situational) information relating to the user, determine a need to provide assistance to the user based on the monitoring, and perform one or more assistive actions for the user. Contextual information may include data regarding a location of the user, calendar/travel-related data associated with the user, data regarding a present time of day, weather data, etc., data regarding an environment of the user (e.g., presence of individuals and/or objects proximate to the user), data regarding communications (e.g., speech/gestures, incoming or outgoing calls, e-mails, text messages, etc.) associated with the user, and/or the like. The VA platform may additionally be configured to obtain user profile/preference/historical data.

In various embodiments, the VA platform may be configured to determine a need to provide assistance to the user based on detecting that the user is distracted, frustrated, stressed, or the like (e.g., based on detecting that the user is texting, looking elsewhere, talking with someone, etc. rather than performing a particular task such as ordering food from a restaurant menu, etc.; based on detecting certain changes in biometrics of the user, such as elevated heartrate, sweating, etc., when faced with a particular task; and/or the like). In some embodiments, the VA platform may be configured to determine a need to provide assistance to the user based on social cue(s). A social cue may relate to timeliness of an action or response in accordance with a determined social or contextual norm, extended silence of the user beyond a threshold period of time (e.g., a determined typical response time for the user or for a particular context), and/or the like. In certain embodiments, the VA platform may be configured to determine a need to provide assistance to the user based on a user command (e.g., a voice-based command, a gesture-based command, or the like).

In some embodiments, the VA platform may, based upon determining a need to provide assistance to the user, identify feedback, memory cues, and/or options or (e.g., soft) recommendations, such as interaction recommendations, for the user. In some embodiments, such as in cases where the user is in a social setting, the VA platform may be configured to identify (e.g., as a reminder or upon detecting that the user is stressed or distracted) memory cues or contextual details on a topic, a person or contact, or the like to assist the user in engagements (e.g., conversations or dialogues) with contact(s). Memory cues or contextual details can include appropriate questions or key topics (e.g., relating to a background of a contact) that the user can ask or bring up with the contact(s) to help facilitate discussions.

In exemplary embodiments, the VA platform may filter potential assistive actions or options, and thereby arrive at a reduced set of actions/options, based on thresholds or preferences (e.g., from user profile data and/or historical user data, such as that relating to interests of, or prior choices made by, the user, individuals associated with the user, etc.). Doing so restrains, or otherwise prevents, the VA platform from identifying recommendations and/or assistive actions that might have high impact on, or consequences for, the user. Thresholds or preferences may, for example, relate to the user's previous purchases, the user's medical conditions (e.g., allergies, etc.), the user's dietary restrictions, the user's budgetary constraints, contextual information, information regarding social norms, and/or the like. In certain embodiments, the VA platform may determine a priority (and/or a sequence) of assistive action(s).

In exemplary embodiments, the VA platform may be configured to perform assistive action(s) for (or on behalf of) the user. In various embodiments, the VA platform may be configured to summarize, select, and/or execute potential actions, options, or recommendations for the user. In some embodiments, the VA platform may cause identified options or recommendations to be presented to the user (e.g., audibly, visually via an augmented reality (AR) object or marker, haptically, or the like) for use, selection, or feedback. In certain embodiments, the VA platform may access one or more external systems/networks, such as Internet-of-Things (IoT) systems, point-of-sale (POS) systems, or the like as part of assisting the user, such as to obtain/gather data/information for the user, conduct transaction(s) for the user, identify travel route(s) for the user, plan one or more itineraries for the user, exchange communications with other individuals, and/or the like.

Embodiments of the VA platform, described herein, thus facilitate timely, lower-priority or lower-impact decision-making for a user, which can relieve the user particularly at times when the user is distracted, frustrated, stressed, or the like. This enables the user to focus on other higher-priority tasks (e.g., conducting a business discussion during a lunch meeting or the like) and have lower consequence tasks (e.g., deciding on what to order from a restaurant menu or the like) delegated to the VA platform. Determining a need to assist the user based on social cues also helps individuals identify or learn social norms. Furthermore, providing conversational reminders, memory cues, contextual details, and/or suggestions (e.g., based on learned and/or discovered insights) in social settings also aids the user in remembering or identifying key topics for discussion, which can facilitate interactions between the user and counterparties and promote discovery of common bonds or the like. Facilitating decision-making in various aspects of a user's life also eliminates or reduces a need for the user to frequently access user devices and communication/data networks to perform casual/ad hoc searching, querying, or the like for ideas, information, or suggestions, which can conserve computing resources and network resources, thereby improving overall device and/or network performance.

One or more aspects of the subject disclosure include a device, comprising a processing system including a processor, and a memory that stores executable instructions that, when executed by the processing system, facilitate performance of operations. The operations can include obtaining information relating to a context associated with a user. Further, the operations can include monitoring, based on the obtaining the information, a behavior of the user relative to the context, determining to provide assistance to the user based on the monitoring the behavior of the user, and responsive to the determining to provide assistance to the user, identifying an assistive action, wherein the identifying the assistive action is based on a predefined threshold. Further, the operations can include, based on the identifying the assistive action, performing the assistive action for the user.

One or more aspects of the subject disclosure include a non-transitory machine-readable medium, comprising executable instructions that, when executed by a processing system including a processor, facilitate performance of operations. The operations can include obtaining information that is associated with a particular contact. Further, the operations can include detecting that a user is engaged in a communication session with the particular contact, responsive to the detecting that the user is engaged in the communication session with the particular contact, monitoring a behavior of the user during the communication session, and determining, from the monitoring the behavior of the user during the communication session, a need to provide assistance to the user. Further, the operations can include, responsive to the determining the need to provide assistance to the user, causing a recommendation to be presented to the user, wherein the recommendation relates to the information that is associated with the particular contact.

One or more aspects of the subject disclosure include a method. The method can comprise receiving, by a processing system including a processor, information relating to a context associated with a user, and monitoring, by the processing system, and based on the receiving the information, a behavior of the user relative to the context. Further, the method can include detecting, by the processing system, and based on the monitoring the behavior of the user, that the user is likely deviating from a contextual norm determined to be relevant in the context, and identifying, by the processing system, a plurality of recommendations or options responsive to the detecting that the user is likely deviating from the contextual norm. Further, the method can include, based on the identifying the plurality of recommendations or options, causing, by the processing system, the plurality of recommendations or options to be presented to the user to assist the user in the context.

Other embodiments are described in the subject disclosure.

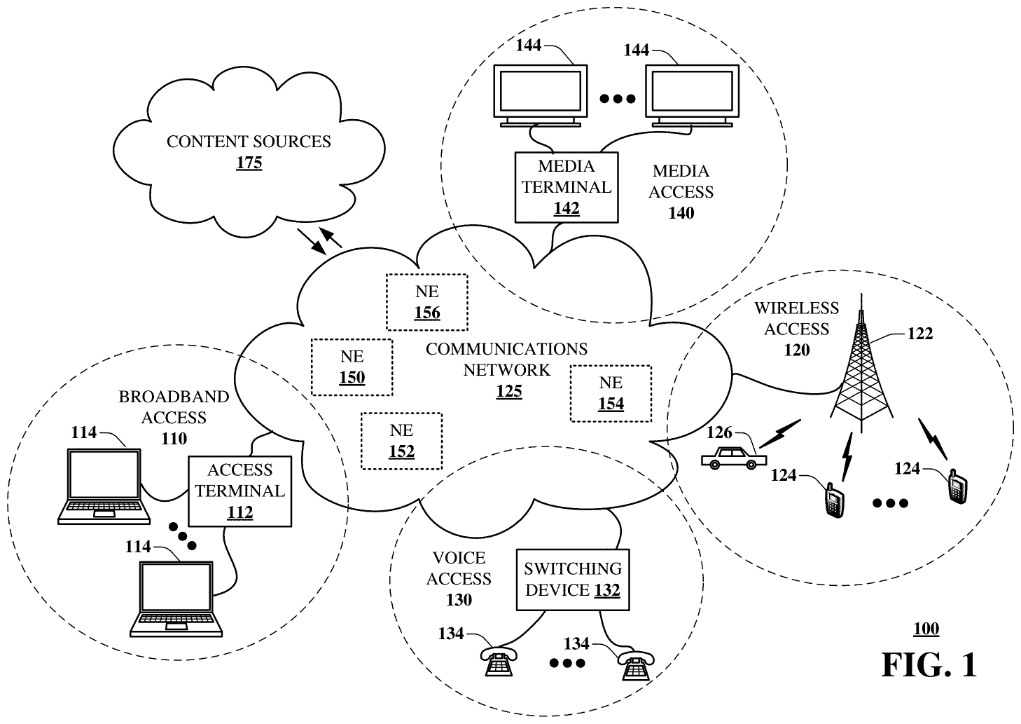

Referring now to FIG. 1, a block diagram is shown illustrating an example, non-limiting embodiment of a system 100 in accordance with various aspects described herein. For example, system 100 can facilitate, in whole or in part, monitoring of the behavior of a user and/or contextual (or situational) information relating to the user, determining a need to provide assistance to the user based on the monitoring, and performing one or more assistive actions for the user. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

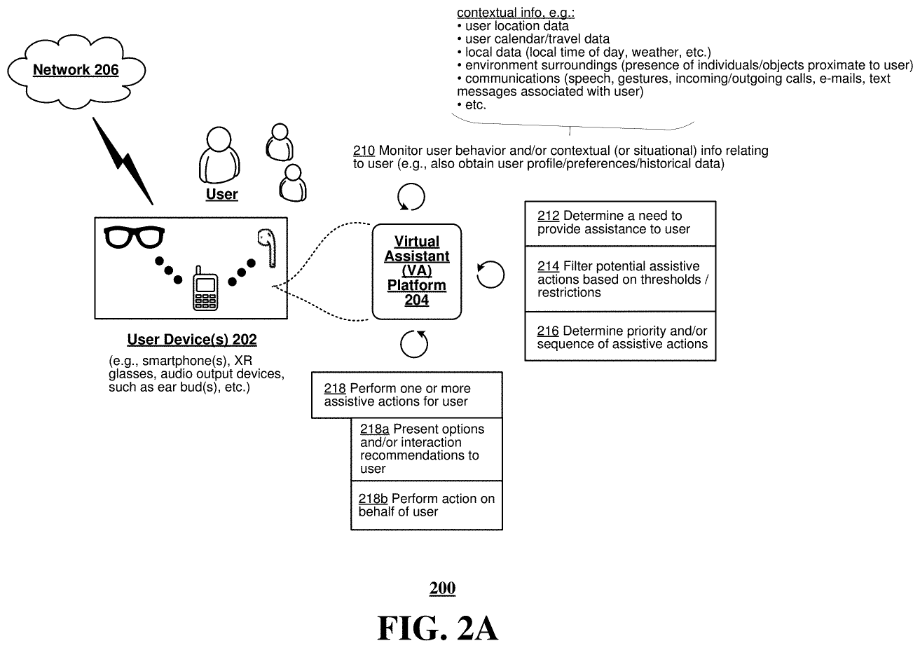

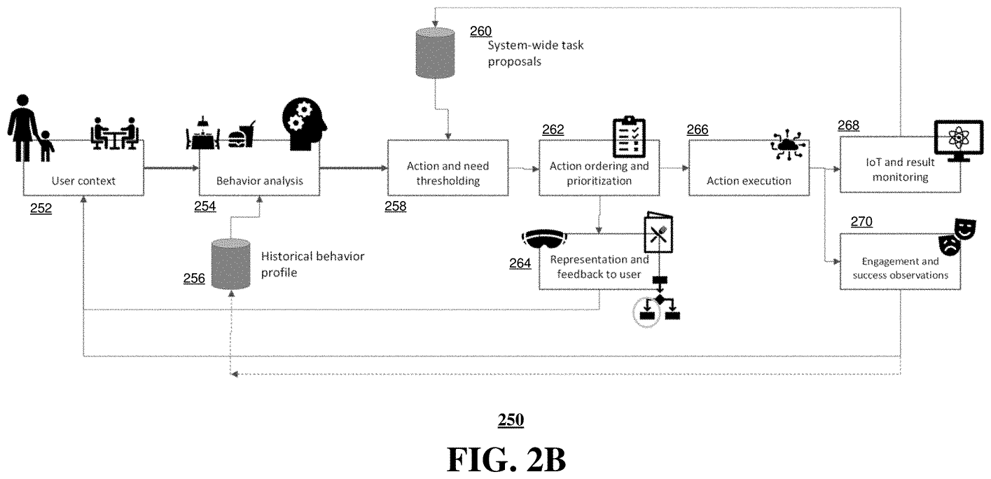

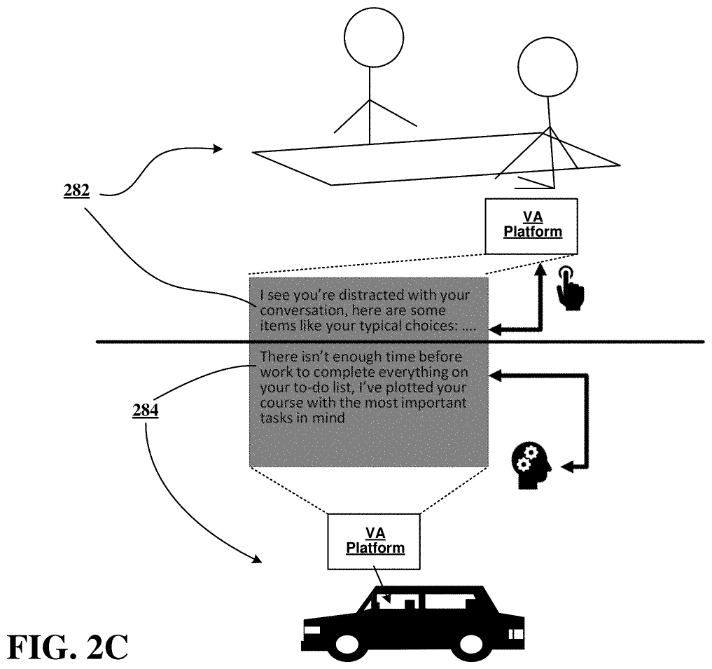

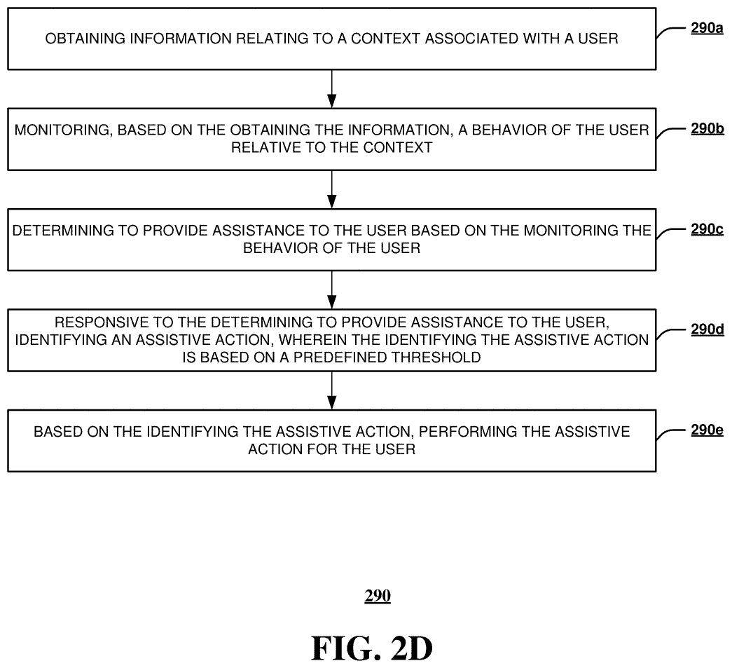

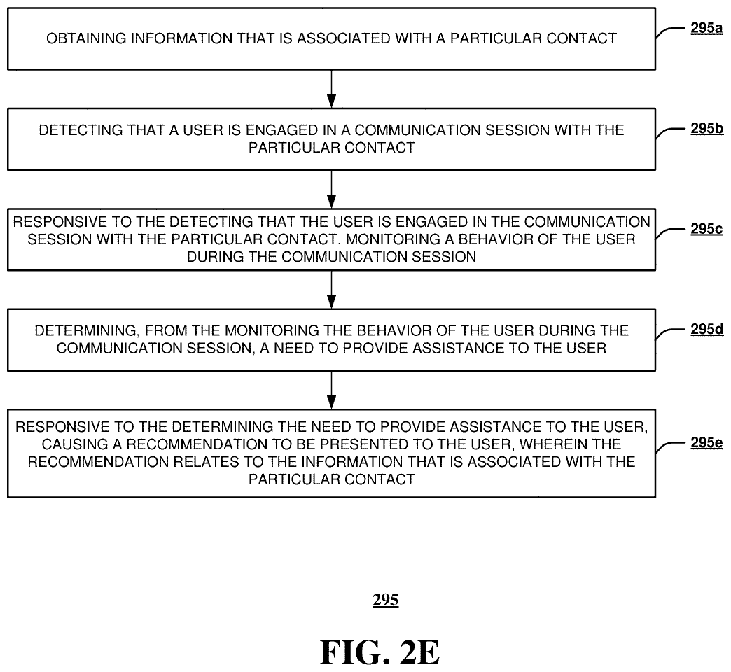

FIG. 2A is a block diagram illustrating an example, non-limiting embodiment of a system 200 functioning within, or overlaid upon, the communications network of FIG. 1 in accordance with various aspects described herein. As shown in FIG. 2A, the system 200 can include one or more user devices 202 equipped with a virtual assistant (VA) platform 204. The user device(s) 202 may include one or more devices capable of receiving, generating, storing, processing, and/or providing data (e.g., audio data, video data, extended reality (XR) data, text data, control data, etc.) relating to the VA platform 204. For example, a user device 202 can include a communication and/or computing device, such as a mobile phone (e.g., a smart phone, a radiotelephone, etc.), a desktop computer, a laptop computer, a tablet computer, a handheld computer, a display device, a gaming device, a wearable communication device (e.g., a smart wristwatch, a pair of smart eyeglasses, media-related gear (e.g., a pair of augmented reality (AR), virtual reality (VR), mixed reality (MR) glasses, a headset, headphones, and/or the like), etc.), a similar type of device, or a combination of some or all of these devices.

The user device(s) 202 and/or the VA platform 204 may be communicatively coupled to one another over a network 206. The network 206 may include one or more wired and/or wireless networks. For example, the network 206 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or a combination of these or other types of networks.

It will be appreciated and understood that the system 200 can include any number/types of users, user devices, platforms, and networks, and thus the number/types of users, user devices, platforms, and networks, shown in FIG. 2A are for illustrative purposes only.

The VA platform 204 can be capable of providing assistance to a user, such as with lower priority (or lower impact/consequence) decisions. In exemplary embodiments, the VA platform 204 may be configured to assist a user with a variety of tasks or decisions in various settings or contexts. In various embodiments, the VA platform 204 may be configured to perform assistive actions for the user (e.g., during situations where the user is determined to be frustrated, distracted, stressed, or otherwise in need of assistance), such as presenting options or recommendations for user consideration, selection, feedback, or the like, or additionally or alternatively, accessing one or more external systems/networks, such as Internet-of-Things (IoT) systems, point-of-sale (POS) systems, etc. to conduct activities on behalf of the user. As some examples, the VA platform 204 may facilitate social interactions for the user (e.g., to promote targeted engagements, bonding with others, etc.), provide overall management of user activities in relation to predefined goals (e.g., goals associated with the user's career or employment trajectory, marketing/sales, business and/or personal relationship development, diet and exercise, such as daily calorie limits and exercise routines or programs, etc.), exchange communications (e.g., via phone, e-mail, text, etc.) with others on behalf of the user, conduct transactions (e.g., online or in-person purchases or the like based on product reviews and/or user preferences) for the user, and/or the like.

As shown by reference number 210, the VA platform 204 may monitor behavior of a user and/or contextual (or situational) information relating to the user. Contextual information may include data regarding a location of the user, calendar/travel-related data associated with the user, data regarding a present time of day, weather data, etc., data regarding an environment of the user (e.g., presence of individuals/objects proximate to the user), data regarding communications (e.g., speech/gestures, incoming or outgoing calls, e-mails, text messages, etc.) associated with the user, and/or the like.

In exemplary embodiments, the VA platform 204 may obtain information relating to the user to determine the user's current behavior or state of mind, such as whether the user is performing an action or is inactive or not responsive (e.g., to external or environmental stimuli), how the user is likely feeling (e.g., physically or emotionally), or the like. The information may include, for example, biometric data (e.g., provided by biometric sensors associated with the user device(s) 202), camera data (e.g., images of the user which the VA platform 204 may utilize to determine the user's posture, gestures, facial expressions, commands, etc.), voice data (e.g., audio recordings of the user which the VA platform 204 may utilize to determine the user's sentiment, tone, commands, etc.), and/or the like.

In various embodiments, the VA platform 204 may obtain other information relating to the user, such as user profile information or the like. Profile information can include data relating to user preferences (e.g., historical explicit preferences, including advertisement placement policy restrictions, opt-in or opt-out preferences, or the like), data relating to user behaviors and/or interests (e.g., historical behaviors, such as Internet browsing activities, content consumption (e.g., videos, games, etc.), purchase histories, and/or the like), demographic data associated with the user (e.g., age of the user, gender of the user, etc.), and/or the like. In some embodiments, the profile information can additionally, or alternatively, include data relating to prior locations of the user (e.g., places that the user has visited, performances/shows/conferences that the user has attended, etc.), which may, for example, be determined based on historical location (e.g., global positioning system (GPS)) data, based on Exif (Exchangeable image file) data from photos previously captured by a camera of the user's smartphone, based on historical calendar data, etc. In certain embodiments, the profile information can additionally, or alternatively, include data relating to prior conversations, discussions, and/or engagements of the user, data relating to advertisement responses of the user (e.g., advertisement exposures, click-through actions, affinities between users and advertisements and/or advertisement types), and/or other data representative or indicative of user activities, preferences, and/or behaviors (e.g., Interactive Advertising Bureau (IAB)-related data, tag data, genre data, embedding data, and/or the like). In some embodiments, the profile information may include social profile data associated with the user (e.g., the user's social media/networking profile). In certain embodiments, the social profile data may include information regarding actions, preferences, activities, and/or the like relating to the user's friends, family, or other connections, such as other users that the user may be following, etc.

As shown by reference number 212, the VA platform 204 may (e.g., based on the monitoring) determine a need to provide assistance to the user. In various embodiments, the VA platform 204 may determine a need to provide assistance to the user based on a contextual norm, such as a determined baseline behavior (e.g., that is “normal” or “typical”) for a present context. In some embodiments, the baseline behavior may be associated with a threshold period of time (e.g., a reaction time) during which it is typical or normal for one to respond (e.g., to a prompt) or to perform a task in the context. In certain embodiments, the VA platform 204 may identify baseline behavior(s) for a given context in accordance with a behavioral model associated with the context and/or associated with the user, such as a model of historical (e.g., typical) behavior of the user in the context or similar contexts. For instance, in a case where the VA platform 204 detects, based on the above-described monitoring, that the user is currently at a hospitality setting, such as a restaurant, that a service attendant has queried the user to place an order, and that the user has not responded to the service attendant and/or has not reviewed the restaurant menu for a threshold period of time (e.g., 30 seconds, 2 minutes, 5 minutes, or the like), and thus is likely deviating from a contextual norm, the VA platform 204 may determine a need to provide assistance to the user to select and/or order a menu item.

In one or more embodiments, the VA platform 204 may determine a need to provide assistance to the user based upon detecting that the user is distracted, frustrated, stressed, or the like. For example, in a case where the VA platform 204 detects, based on the above-described monitoring, that the user is texting, looking elsewhere, talking with someone, etc. rather than performing a particular task, such as ordering food from a restaurant menu, etc. (which may, for example, be indicative of the user being distracted or overwhelmed within the context), the VA platform 204 may determine a need to provide assistance to the user to select and/or order a menu item. As another example, in a case where the VA platform 204 detects, based on the above-described monitoring, that, when the user is faced with a particular task, there are certain changes in biometric data of the user, such as elevated heartrate, sweating, and/or the like (which may, for example, be indicative of the user being frustrated, stressed, or the like), the VA platform 204 may determine a need to provide assistance to the user with regard to the particular task. As yet another example, in a case where the VA platform 204 detects, based on the above-described monitoring, that the user is acting in contrary to, or in conflict with, a predefined goal—e.g., is ordering a meal that has a number of calories in excess of the user's predefined daily calorie limit—the VA platform 204 may determine a need to provide assistance to the user so as to flag the issue to the user.

As shown by reference number 214, the VA platform 204 may identify (e.g., filter) potential assistive actions and/or recommendations based on thresholds or restrictions. In various embodiments, the thresholds and/or restrictions may be predefined (e.g., set by the user; built-in by default, such as by a business or enterprise associated with the VA platform 204; and/or the like). In some embodiments, the thresholds and/or restrictions may be learned (e.g., by monitoring the user's reactions or responses to assistive actions performed, or decisions made by, the VA platform 204; by accessing a central repository of thresholds and/or restrictions determined to be useful for or relevant to the user; based on one or more machine learning algorithms; and/or the like).

It is to be appreciated and understood that the VA platform 204 may take into consideration any type of threshold or restriction when determining assistive actions to be performed, or decisions to be made, for the user. As one example, the user may predefine, or the VA platform 204 may learn (e.g., from the user's prior purchases), a price limit that caps the amount at which the VA platform 204 is authorized to spend on transactions (e.g., purchases of products or services) conducted on behalf of the user. Continuing the example, the user may set one or more price limits for one or more categories of transactions (e.g., apparel, groceries, food, rentals, etc.). As another example, the user may identify, or the VA platform 204 may learn (e.g., based on monitoring user inputs, biometric data, or the like), the user's medical conditions or dietary restrictions, such as allergies or the like, which the VA platform 204 may take into consideration when identifying recommendation(s)/option(s) for the user and/or when determining assistive action(s) to be performed, or decision(s) to be made, for the user. Continuing the example, the VA platform 204 may avoid recommending and/or ordering food items that contain ingredients to which the user may be allergic, avoid planning trips to places that contain levels of dust or allergens that may irritate the user, select destinations for the user that are equipped with certain features (e.g., wheelchair accessibility in a case where the user is handicapped), and so on. As a further example, the user may define, or the VA platform 204 may learn (e.g., based on monitoring user inputs, etc.), distance-related thresholds, which the VA platform 204 may use when identifying recommendation(s)/option(s) for the user and/or when determining assistive action(s) to be performed, or decision(s) to be made, for the user. Continuing the example, in a case where the user is en route to a destination, the VA platform 204 may plan an excursion to a location of potential interest (e.g., a museum, a theme park, and/or the like based on user preferences or historical data) that is within a defined threshold distance from the user's route, and avoid selecting points of interest that are beyond the threshold distance. As yet another example, the user may define, or the VA platform 204 may learn (e.g., based on monitoring user inputs, etc.), schedule- or time-based thresholds, which the VA platform 204 may use when identifying recommendation(s)/option(s) for the user and/or when determining assistive action(s) to be performed, or decision(s) to be made, for the user. Continuing the example, in a case where the VA platform 204 determines that the user's schedule is full after a certain time (e.g., in the afternoon) and/or where the user indicates that the user does not wish to engage in any activities on a particular day after a particular time (e.g., Sundays after dusk), the VA platform 204 may arrange for and/or book events for the user to attend or participate in based on the user's defined time constraints.

In various embodiments, the VA platform 204 may be configured to filter/adapt potential assistive actions and/or recommendations based on a determined social context or connection, based on an assessment of social interaction impacts on the user, and/or based any implicit thresholds identified by the VA platform 204 in accordance with determined criticality of a decision or topic, determined user sentiment, or the like. Thresholding assistive actions and/or recommendations in this way can protect user privacy or otherwise avoid creating awkward or unpleasant experiences for the user. As an example, in a case where the VA platform 204 determines that the user is engaging with a stranger (e.g., an unknown contact) or a professional contact, the VA platform 204 may refrain from recommending conversational topics that relate to the user's personal life (e.g., anecdotes concerning the user's family member, information regarding the user's financial status, recent embarrassing incidents, such as the receipt of a speeding ticket, etc.), whereas the VA platform 204 may not refrain from doing so in a case where the VA platform 204 determines that the user is otherwise engaging with a close contact (e.g., a friend or the like).

In some embodiments, the VA platform 204 may be configured to identify, learn, and/or adjust thresholds or restrictions based upon a status associated with the user. For instance, in a case where the VA platform 204 determines (e.g., based on the user's profile information, based on leanings from monitoring of the behavior of the user, and/or the like) that the user is likely financially stable or well off (e.g., has financial means, such as income, savings, etc. beyond a certain amount or the like), the VA platform 204 may adjust (e.g., increase) allowable spending-related thresholds.

In this way, the VA platform 204 may perform assistive actions for the user and/or provide (e.g., metered) recommendations to the user within a set of bounds, thereby refraining from acting in manners that may be unfavorable or undesirable (e.g., within a given context) or refraining from making “life-changing” decisions on behalf of the user. Additionally, by leveraging threshold and/or restriction data, the VA platform 204 can limit or reduce the number of recommendations or options, which may avoid inundating or overwhelming the user.

As shown by reference number 216, the VA platform 204 may determine priorities for assistive actions and/or a sequence of the assistive actions. In various embodiments, the VA platform 204 may derive or orchestrate a sequence of assistive actions as part of planning out a daily schedule for the user. For instance, the VA platform 204 may, based on input provided by the user and/or based on determining a daily routine that the user typically follows (e.g., drop off kids at a certain time, stop by a coffee shop thereafter, call a family member, etc.), identify appropriate travel routes for the user in accordance with traffic conditions and/or the user's preferences (e.g., where the user tends to avoid certain geographic areas or generally prefers to traverse through a particular area for its scenery), arrange routine/additional activities that fit the user's schedule or time constraints, and/or the like.

In exemplary embodiments, the VA platform 204 may additionally, or alternative, derive or orchestrate a sequence of assistive actions based on determined time-based, social, and/or financial/economic impacts to the user. For example, the VA platform 204 may, based upon determining that the user has a certain purchase limit for ordering food at a restaurant, and that the user has thirty minutes to consume a meal prior to a business-related meeting, the VA platform 204 may recommend a simpler meal option (e.g., a chicken salad instead of a steak) for the user such that the user can finish the meal quickly and arrive at the meeting on time.

In some embodiments, the VA platform 204 may postpone, for the user, certain decisions to a later time or date based on determining that the user is currently occupied. For instance, in a case where the VA platform 204 detects that the user is performing a particular activity, such as researching and deciding on a topic for a blog post, and is interrupted (e.g., by an incoming call), the VA platform 204 may document the user's progress and/or set a reminder to jog the user's memory at a later point (e.g., after the call ends, later in the evening, or the like) to assist the user in revisiting the activity.

As shown by reference number 218, the VA platform 204 may perform one or more assistive actions for the user. For example, as shown by reference number 218a, the VA platform 204 may present options and/or interaction recommendations to the user (e.g., for user consideration, selection, or feedback). In one or more embodiments, the VA platform 204 may provide audible hints or visual AR markers around the user. For example, in a case where the user device 202 includes XR glasses and/or an audio output device (e.g., earbuds), and where the VA platform 204 determines that the user is located at a restaurant and is reading a physical menu, the VA platform 204 may audibly identify potential food options for the user and/or may provide AR content over the physical menu that visually identifies the potential food options for the user. Continuing the example, in a case where the VA platform 204 determines that the user is allergic to a certain type of food, that the user has a certain number of remaining calories that the user can consumer for the day, or that the user has a spending limit for food, the VA platform 204 may provide AR content in a manner that hides, or restricts from the user's view, any food options on the physical menu that the user may be allergic to, that exceed the user's remaining calories, or that exceed the price limit.

In various embodiments, the VA platform 204 may present the options and/or interaction recommendations in a manner that enhances the user experience (UX). In a case where the user device 202 includes a graphical interface, the VA platform 204 may prominently display (e.g., by coloring, emboldening, and/or the like) certain text, images, or graphics to cue the user to particular options.

In certain embodiments, the VA platform 204 may cluster or branch recommendations based on detected communication session (e.g., conversation or interaction) flows. For example, in a case where the VA platform 204 determines that the user is engaged in a meeting with a professional contact, the VA platform 204 may group certain conversation points (which the VA platform 204 may, for example, customize or filter based on user privacy, as described above) regarding the user's background, employment history, and/or specific topics (e.g., conversation starters or the like), and present/recommend such conversation points at different times during the engagement based on the flow of the conversation. Continuing the example, the VA platform 204 may present a recommendation to discuss the user's new book based upon detecting that the professional contact is inquiring about the user's recent projects, present a recommendation to discuss recent films that the user has watched based upon detecting that the conversation flow is leading towards personal interests, etc.

In various embodiments, the VA platform 204 may obtain (e.g., pull in) data from various data sources in real-time (or near real-time), and utilize such data to identify assistive actions and/or recommendations. Data sources may include, for example, audio-based input, camera-based data (e.g., images of a prospective contact that the user has indicated a desire to engage with at a social event), public records (e.g., search engine results identifying certain works with which the prospective contact is associated), communication records (e.g., e-mails that the user may have exchanged with a business contact), the user's personal notes, and/or the like. In one or more embodiments, the VA platform 204 may cluster the various data and (e.g., jointly) present the data to the user to facilitate social interactions for the user, which may promote social connection or bonding, open pathways to new opportunities, and so on.

In exemplary embodiments, the VA platform 204 may suggest new experiences for the user (e.g., automatically or based upon determining that the user has opted-in to receive such suggestions). In various embodiments, the VA platform 204 may analyze (e.g., complex subcomponents of) the user's historical behavior/choices/decisions/purchases, profile information, interests, predefined thresholds or restrictions, and/or the like, and may recommend new experiences for the user (e.g., new entertainment sources, dining options, recipes, entrées, activities, destinations to visit, and so forth) based thereon. In a case where the VA platform 204 determines that the user is engaging in a new experience (e.g., has arrived at a particular donut shop that is different from the user's typically-frequented donut shop), the VA platform 204 may (e.g., automatically or based upon user command) provide assistance to the user in understanding, appreciating, or otherwise contextualizing, the new experience (e.g., by mapping, and presenting the mapping of, donut offerings at the particular donut shop to similar donut offerings at the user's typically-frequented donut shop).

In one or more embodiments, the VA platform 204 may provide audible hints or visual AR markers in response to the user's behavior or actions. For instance, in a case where the VA platform 204 detects that the user has ordered a particular food item on a restaurant menu, and where the VA platform 204 determines that other more suitable food options (e.g., less expensive ones that satisfy cost-related thresholds, ones with fewer calories which would better align with the user's dietary goals, ones that are determined to take less time to prepare/cook and thus are better suited to the user's tight schedule, or the like), the VA platform 204 may cause such alternative food options to be presented to the user.

As shown by reference number 218b, the VA platform 204 may perform one or more assistive actions on behalf of the user. In various embodiments, the VA platform 204 may communicatively couple with one or more external systems (e.g., IoT devices, POS systems, communications systems, or the like) to provide assistance to the user. For example, the VA platform 204 may automatically communicate with external devices or networks to conduct transactions for the user (e.g., to initiate purchases or the like), to plan and/or update itineraries or travel routes for the user, exchange communications (e.g., calls, e-mails, text messages, etc.) with other individuals, and so on. As another example, the VA platform 204 may generate visual and/or audible outputs on behalf of the user, such as in response to inquiries or requests directed at the user (e.g., at a hospitality setting or the like). In some or all instances in which the VA platform 204 provides assistance to the user, the VA platform 204 may present options/alternatives for user selection or feedback. Additionally, or alternatively, the VA platform 204 may identify and select one or more of such options/alternatives on the user's behalf (e.g., automatically, based upon not detecting any response from the user for a threshold period of time, or the like).

In various embodiments, the VA platform 204 may be capable of adjusting choice mapping based on real-time, near real-time, or predetermined assessments of the user's skills, abilities, background, geographic location, and/or the like. In some embodiments, for example, the VA platform 204 may be configured to identify, adapt, and perform potential assistive actions for a user, and/or identify, adapt, and present recommendations for the user, based on user demographic information, user cultural background information, information regarding assessed skills, determined conditions or disorders (e.g., color blindness, developmental conditions, such as autism, etc.), and/or the like. In certain embodiments, the VA platform 204 may determine such information from the user's profile and/or based on learnings from monitoring of the behavior, expressions, manner of speech, word selection, etc. of the user or of large set(s) of user cohorts over time. As an example, in a case where the VA platform 204 determines that the user is not fluent in a language (e.g., English, etc.), is still in the processing of learning the language, has difficulty reading dense textual passages, is a child, has a developmental disorder, and/or the like, the VA platform 204 may identify and/or adapt assistive actions and/or recommendations by rephrasing certain text using simpler words or less complex sentence structure, substituting images for text (which may, for example, be helpful to the user in a situation where the user is viewing a foreign menu and is confused about food options), and/or the like. Continuing the example, the VA platform 204 may additionally, or alternatively, present certain recommendations or options multiple times or in multiple manners (e.g., visually, audibly, and/or haptically) so as to confirm the user's recommendation selections or choices. Further continuing the example, the VA platform 204 may additionally, or alternatively, present certain recommendations or options for a longer period of time so as to permit the user to fully comprehend the recommendations or options. As another example, in a case where the VA platform 204 determines that the geographic location of the user has changed (e.g., that the user is in a different country), the VA platform 204 may identify, adapt, and perform potential assistive actions for the user, and/or identify, adapt, and present recommendations for the user, differently. Continuing the example, the VA platform 204 may adapt recommendations or options in accordance with known customs that are practiced in the geographic region (e.g., by avoiding scheduling activities that may result in the user consuming a meal while on the move or on the go, which may be impolite in certain cultures).

In various embodiments, the VA platform 204 may be configured to identify, adapt, and perform potential assistive actions for a user, and/or identify, adapt, and present recommendations for the user, based on one or more other individuals being present with the user, based on the user acting as a proxy or being in the care of one or more other individuals (e.g., a parent, child, or relative), or the like. As an example, in a case where the VA platform 204 determines (e.g., based on user profile information, based on learnings from monitoring of the behavior of the user and/or others in the presence of the user, and/or the like) that the user is an emergency contact for an aging parent of the user, that the user is likely receiving an incoming call concerning the aging parent, and that the user is unable (or not present) to answer the call, the VA platform 204 may (e.g., automatically, based on the user's predefined permissions, or the like) respond to the caller, such as with an indication that the user is not available at the moment and will return the call shortly, and may provide/present one or more (e.g., repeated) notifications or reminders to the user to ensure that the user is aware of the call when the user returns or is no longer busy. As another example, in a case where the VA platform 204 determines that the user is late to pick up a child from school but is en route to the school, that the user is receiving an incoming call from the school, and that the user is unable to answer the call, the VA platform 204 may (e.g., automatically, based on the user's predefined permissions, or the like) respond to the caller, such as with an indication that the user is unable to answer the call at the moment, but is on the way to the school and will arrive within an approximate time period based on the user's current location relative to the school. Continuing the example, in a different situation where the VA platform 204 determines that the user is late to pick up the child from school and is not en route to the school, that the user is receiving an incoming call from the school, and that the user is unable to answer the call, the VA platform 204 may (e.g., automatically, based on the user's predefined permissions, or the like) respond to the caller, such as with contact information for a trusted individual (e.g., the user's significant other or friend) who may be available to pick up the child, or additionally, or alternatively, may communicate with the trusted individual (e.g., via a call, a text alert, an e-mail, or the like with a prerecorded message) to inform/request the trusted individual to help pick up the child from school. As a further example, in a case where the VA platform 204 determines to make a reservation for the user at a restaurant or a show, and determines (e.g., based upon detecting a current context, based upon detecting a presence of another person with the user and thus a (e.g., possible) change to the current context, and/or the like) that the user is, or will be, in care for, and thus joined by, an individual having a mobility impairment, such as a disabled parent that is wheelchair bound or the like, the VA platform 204 may identify and select establishments (and/or make adjustments to previously-selected establishments based upon detecting a change to the context) that are handicapped accessible.

In various embodiments, the VA platform 204 may perform follow-up actions relating to assistive actions. In some embodiments, the VA platform 204 may obtain feedback from the user regarding an assistive action, and perform a follow-up action based on the feedback. For example, the VA platform 204 may, based upon performing an assistive action (e.g., scheduling a meeting for the user, conducting a transaction for the user, providing a recommendation for a social engagement, generating and providing a prioritized to-do list, etc.), monitor for user feedback with respect to the assistive action. Continuing the example, if the VA platform 204 detects that the user performed a modification associated with the assistive action (e.g., rescheduled the meeting, canceled the transaction, ignored the social engagement recommendation, reprioritized items in the to-do list, etc.), the VA platform 204 may update the user's profile information or preference data, update a behavior model associated with the user, or the like for improved assistive decision-making for the user in the future.

As another example, the VA platform 204 may perform modifications associated with prior assistive actions (e.g., cancelling or rescheduling appointments for the user, cancelling or modifying scheduled purchases, etc.) based upon identifying updates or changes to user profile information, user preferences, contextual information, and/or the like. In some embodiments, the VA platform 204 may enable the user to personalize certain assistive actions and/or modifications associated with prior assistive actions. For example, in a case where the VA platform 204, as part of prioritizing the user's schedule, determines to cancel one of the user's meeting to accommodate a different, higher-priority activity for the user, the VA platform 204 may provide an opportunity for the user to review the potential cancellation and include a message (e.g., an apology or the like) to the cancellation notice, which may enable the user to evaluate the proposed cancellation and to customize or personalize the cancellation notice (e.g., to avoid social implications). In one or more embodiments, the VA platform 204 may learn the level of consequence (or priority of) of an item or action based upon the user's (e.g., prior historical) acceptance of (or how often the user accepts) a certain assistive action 218 proposed by the VA platform 204. For example, in a restaurant scenario, where the VA platform 204 determines that the VA platform 204 tends to perform an assistive action 218 (e.g., always performs the action or has done so for a threshold number of times) to order an appetizer (possibly regardless of what the actual appetizer is) for the user without protest from the user, the VA platform 204 may presume that ordering appetizers for the user is a low consequence (or low priority) action. On the contrary, the VA platform 204 may determine that a particular assistive action 218 relates to a higher consequence (or higher priority) item in a case where the VA platform 204 identifies (e.g., based upon detecting behavioral monitoring at 210 or based upon detecting direct interaction by the user, such as in the form of feedback to the user device 202) that the user consistently (e.g., for more than a threshold number of times) protests, or otherwise indicates an avoidance for certain proposed assistive actions (e.g., even after the VA platform 204 performs filtering at 214). In some embodiments, the VA platform 204 may learn the level of consequence (or priority of) of an item or action based upon detected impact to the user's behavior in various contexts. For example, the VA platform 204 may associate detected user frustration or satisfaction with one or more thresholds, which the VA platform 204 may use to inform which assistive actions may be taken, how to prioritize assistive actions prior to presenting proposed actions to the user, and/or the like. Continuing the example, a threshold may include monetary costs or restrictions that the VA platform 204 may consider when deciding on purchasing-related assistive actions, trip distance restrictions that the VA platform 204 may consider when deciding on navigation options for the user, time lost for the user that the VA platform 204 may consider when deciding on scheduling-related assistive actions, and/or the like.

In certain embodiments, perceived user frustration or satisfaction may be associated with an assistive action that occurred in the past. For example, the VA platform 204 may have automatically placed an order for a product online, but where the VA platform 204 may detect user frustration after the user receives and is utilizing that product. In this example, the VA may associate current user behavior 210 to a historical assistive action 218.

In some cases or for some contexts, therefore, the VA platform 204 may not perform a particular assistive action (that is, may not perform an assistive action at all) if available (e.g., all available) assistive actions are filtered by threshold(s) (e.g., at 214) and/or eliminated by determined level of consequence (or priority).

FIG. 2B is a block diagram illustrating an example, non-limiting embodiment of a system 250 functioning within, or operatively overlaid upon, the communications network of FIG. 1 in accordance with various aspects described herein. In various embodiments, the system 250 may be similar to the system 200 and/or the VA platform 204 of FIG. 2A. For example, the system 250 may perform functions similar to those described above with respect to the VA platform 204, such as functions relating to assisting a user with lower priority (or lower impact/consequence) decisions. In various embodiments, the system 250 can (e.g., similar to that described above with respect to the VA platform 204) be configured to learn, map, and/or propose (e.g., via a suggestion and choice mapping system, such as that based on machine learning, conditional mapping (e.g., if/then/else or the like) and/or other mapping techniques, and/or the like) reduced sets of decisions/feedback for a user, for example, by monitoring the behavior of the user and/or contextual (or situational) information relating to the user, determining a need to provide assistance to the user based on the monitoring, and performing one or more assistive actions for the user responsive to the determined need.

It is to be appreciated and understood that the system 250 (and/or the VA platform 204 of FIG. 2A) can be used in a variety of contexts and can assist a user in numerous ways. As one example, the system 250 can assist a user with ordering food from a menu at a restaurant (e.g., context 252). In this case, the system 250 may monitor and/or analyze (254) the user's behavior, which may include obtaining and analyzing historical user behavior information (256), user profile/preferences, and/or the like. Historical information and/or user profile/preferences may include data regarding the user's prior purchases of food items, food-related preferences (e.g., preferred levels of spiciness, flavors, colors, texture, and/or the like), dietary restrictions, food allergies, etc. Where the system 250 monitors the user's behavior and identifies triggers or cues—e.g., that the user is not ordering food within a threshold period of time (where, for example, the determined contextual norm is for one to order food within a threshold period of time after being seated at the restaurant or to respond to a service attendant within a threshold period of time after being prompted by the service attendant, or the like), that the user appears to be distracted (e.g., is focusing the user's view on another person, or is talking to the other person, rather than reviewing the menu, such as shown by reference number 282 of FIG. 2C), that the user appears to be stressed, confused, or frustrated (e.g., has elevated heart rate, breathing rate, etc.; has uttered phrases indicative of user stress or frustration, such as “I can't decide what do eat” or “There are too many options to choose from;” has flipped the menu back and forth more than a threshold number of times without making a decision; or the like), that the user has explicitly requested help from the system 250 (e.g., via a gesture-based command, a voice-based command, or the like for the system 250 to choose a food item for the user and/or to identify and make some or all of the (low-priority) decisions for the user at the restaurant and/or for a duration of time (e.g., the next thirty minutes)), etc.—the system 250 may determine to provide assistance to the user. Here, the system 250 may, for example, perform (258) one or more actions, such as identifying one or more food options, prioritizing (262) and presenting (264, 266) (e.g., visually, via voice-based guidance, or the like) the food option(s) to the user for consideration or feedback, and/or selecting/ordering (266) a particular food item on behalf of the user. In various embodiments, the system 250 may perform thresholding (258) (e.g., as described above with respect to the VA platform 204 of FIG. 2A) by weighing the various options based on the historical information and/or user profile/preferences, assigning scores to each of the options, ranking the options based on the scores, filtering the options based on the rankings/scores to arrive at a reduced set of options, and/or the like. In some embodiments, the system 250 may interact with the user and/or monitor (268) the user's responses to the system 250's recommended option(s) or proposed assistive action(s), and perform (260) any modifications or adjustments to such option(s) or proposal(s) and/or update (256, 270) the historical information and/or user profile/preferences based on the user's responses or behavior.

In one or more embodiments, a level of consequence (or priority) of an item or assistive action may be determined by the system 250 by correlating historical behaviors (e.g., reaction time) with a given user context. For example, where the system 250 presents a proposed assistive action, and detects that the user responds immediately (e.g., within a threshold period of time) with a selection or approval, the system 250 may determine that the assistive action may have a low level of consequence (or priority) for the user. In some cases, the user may exhibit different behaviors for certain proposed assistive actions depending on the presence of other users. For example, where the user (e.g., serving as a sales provider) is having a business-based lunch with a customer (e.g., serving as a purchaser), and the user prioritizes some or all of the system 250's proposed assistive actions that involve the customer (e.g., food ordering, etc.), the system 250 may detect a change in context relative to prior user history (e.g., where the user may have typically been slow to order a main course, may have typically dined alone, etc.) that may increase the level of consequence (or priority) of certain items or assistive actions, which the system 250 may take into account when filtering assistive actions, prioritizing assistive actions, and/or presenting proposed assistive actions. In some embodiments, the system 250 may prioritize assistive actions that are perform on behalf of, or that relate to, another individual (e.g., the user's ward or elderly parent) (e.g., based upon determining or inferring from the user's profile information or the like the user's social relationship with that other individual).

In some embodiments, the system 250 may be configured to obtain updates to information associated with a particular destination (e.g., updated menu of a restaurant that the user will be visiting, etc.), and present the updated information to the user in advance and/or utilize such updated information as part of providing assistance to the user (e.g., in the form of recommendations, performance of assistive actions, etc.).

As another example, the system 250 can assist a user in a social or professional setting (e.g., context 252) by functioning as an intermediary system that retrieves relevant facts or other information that may be useful for the user in social engagements. For instance, it may be helpful to the user if the system 250 were to provide (e.g., key or important) information or contextual details regarding one or more other people that the user is engaging or desires to engage with. Such information can, for example, aid the user for ice breaker purposes, aid the user in contributing to a conversation with another person, aid the user and the person in identifying commonalities, such as mutual backgrounds, interests, or areas of compatibility, etc. It may also be helpful to the user if the system 250 were to provide memory cues or the like relating to the other person (e.g., items of interest, topics, blogs or books that the other person may have written, etc.) to assist the user in asking appropriate questions or discussing key items, and thereby facilitate the flow of the conversation. Continuing the example, in a case where the system 250 determines that the user is attending a social event, and that the user's goal is to socially engage with a particular attendee or to network with certain types of attendees, the system 250 may (e.g., automatically or on-demand by the user) obtain data from devices or sensors (e.g., cameras, audio input devices, or the like) in an environment of the event, perform image/facial/audio recognition on the data (e.g., to identify the presence and/or locations of the various attendees), obtain biographical details, social media posts, or other information relating to identified attendees (e.g., via the Internet, via social media, and/or the like), and provide (e.g., 258, 262, and/or 266) a corresponding summary for the user to aid the user in locating and socially engaging with individual attendees. The system 250 may additionally, or alternatively, provide (e.g., 258, 262, and/or 266) suggested “starter” topics, relevant topics, etc. to facilitate the flow of conversation(s), subject to thresholding or restrictions (e.g., as described above with respect to the VA platform 204 of FIG. 2A).

As a further example, the system 250 can assist a user in determined time-sensitive situations where the user may be overwhelmed and/or may need to plan out tasks or make quick (e.g. low-priority) decisions (e.g., as shown by reference number 284 of FIG. 2C). In some cases, the system 250 may be cognizant of, or may have planned out, the user's daily tasks or routines, and may adjust the tasks or routines in response to detecting changes or unexpected occurrences that may impact scheduling. For instance, the system 250 may arrange a schedule of tasks for the user on a particular day (e.g., based on data regarding the user's typical routine), and determine an impact to the schedule (e.g., that the user has opted to perform a later-scheduled task, such as dropping off the kids at school, prior to an earlier-scheduled task, such as picking up coffee from the coffee shop). In such a case, the system 250 may identify, and provide information regarding, a travel route from the school to the coffee shop, and update the route based on changing traffic conditions, user preferences or defined thresholds (e.g., distance-based thresholds), or the like.

In a different case where the system 250 determines that a current time is within a threshold time from when the user needs to perform a health-related task, such as taking medication or the like, and where the system 250 detects that the user is about to embark on a journey to work, the system 250 may, for example, present a reminder or suggestion to the user to take the medication prior to leaving the home. Depending on whether the system 250 determines that the user is running late to work, the system 250 may or may not arrange a pre-order of coffee at the user's preferred daily coffee shop en route to work. Here, for example, the system 250 may query the user on whether to forgo the coffee or not.

As yet another example, the system 250 can assist a user in planning activities or events. For instance, based upon detecting that the user is searching or browsing for items or things of interest, such as entertainment content, dining options, places to visit, and so on, the system 250 may conduct searches for, and identify, particular items or things of interest (e.g., in accordance with the user's previously-defined interests, restrictions, historical data, or the like) and/or provide corresponding recommendations to the user.

In this way, the system 250 may (e.g., automatically, based upon detecting a user request, based upon detecting user inaction, etc.) provide or present memory cues or recommendations and/or perform assistive actions on behalf of the user, may monitor the user for responses/feedback (e.g., cadence of the user's responses, tone of the user, biometric data associated with the user, etc.) and/or the environment for social cues or the like, may define and/or adjust priorities and sequences of tasks, assistive actions, etc., and may update historical database(s) of user behavioral information, user profile information, user preferences or the like to provide overall assistance to the user with (e.g., low-priority) decisions such that the user can focus on other (e.g., high-priority) matters. Providing (e.g., a reduced set of soft) recommendations or options, based on prior context or historical data and/or based on mapping of choices, priorities, and preferences in accordance with a user's profile or that of the user's cohort, also assists the user in new contexts or environments.

In various embodiments, the system 250 may be configured to stack dependencies and/or prioritize recommendations that are determined to be urgent or most impactful. For instance, the system 250 may prioritize recommendations based on any relevant, preselected categories, such as health, finance, etc. Additionally, or alternatively, the system 250 may prioritize recommendations by balancing the user's competing priorities, such as serious/consequential activities versus those for leisure/fun, in light of preset restrictions, such as budgetary constraints or the like. In one or more embodiments, dependency stacking may involve multiple assistive actions that are proposed (258, 260) by the system 250. For example, in a dining scenario, some assistive actions may include ordering multiple courses, facilitating the flow of a conversation (e.g., to assist the user in a sales transaction with a client), and paying for the meal. In this example, some or all of these actions may need to be performed, but their respective times of executions (e.g., at 266 of FIG. 2B) may depend on the perceived context (e.g., 282 of FIG. 2C), which may expedite or delay such executions. As another example, with itinerary planning (e.g., 284 of FIG. 2C), the sequencing and stacking of certain assistive actions may eliminate available time for other actions. In this example, certain actions from a library of proposals (e.g., 260 of FIG. 2B) may be automatically suppressed from presentation (e.g., at 264 of FIG. 2B) to the user since they may be too low in priority (e.g., according to 262 of FIG. 2B) (e.g., less than a threshold) as determined by either automated execution performance (e.g. time, cost, choice ambiguity, etc.) (e.g., according to 268 of FIG. 2B) or overall engagement and success (e.g. increased user satisfaction from accomplishing some or all of available or proposed actions/tasks available from 260) (e.g., according to 270 of FIG. 2B).

In one or more embodiments, the system 250 may be configured to correlate activities or events with certain behavioral patterns or physiological changes (e.g., increases in blood pressure whenever the user watches a sports program or is consuming salty food; increases in spending on certain days, such as on pay days; etc.), and utilize such correlations in the system 250's identification of recommendations and/or performance of assistive actions. In one embodiment, the system 250 may (e.g., visually or audibly) provide encouragements to reach predefined goals, applaud the user for reaching such goals, and/or admonish (or “shame”) the user for failing to take action(s) to meet such goals or taking action(s) that conflict with such goals.

While aspects of the VA platform 204 and the system 250 have been described in relation to certain use cases, it is to be appreciated and understood that the VA platform 204 and the system 250 are not limited to such use cases and can be utilized in various other ways and contexts.

It is to be understood and appreciated that the quantity and arrangement of user devices, platforms, systems, functions, and networks shown in FIGS. 2A and/or 2B are provided as an example. In practice, there may be additional user devices, platforms, systems, functions, and networks than those shown in FIGS. 2A and/or 2B. For example, the system 200 and/or the system 250 can include more or fewer user devices, platforms, systems, functions, and networks, etc. In practice, therefore, there can be hundreds, thousands, millions, billions, etc. of such user devices, platforms, systems, functions, and networks. In this way, example system 200 and/or system 250 can coordinate, or operate in conjunction with, a set of user devices, platforms, systems, functions, and networks and/or operate on data sets that cannot be managed manually or objectively by a human actor. Furthermore, two or more user devices, platforms, systems, functions, or networks shown in FIGS. 2A and/or 2B may be implemented within a single user device, platform, system, function, or network, or a single user device, platform, system, function, or network shown in FIGS. 2A and/or 2B may be implemented as multiple user devices, platforms, systems, functions, or networks. Additionally, or alternatively, a set of user devices, platforms, systems, or networks shown in FIGS. 2A and/or 2B may perform one or more functions described as being performed by another set of devices, platforms, systems, or networks shown in FIGS. 2A and/or 2B.

FIG. 2D depicts an illustrative embodiment of a method 290 in accordance with various aspects described herein. In some embodiments, one or more process blocks of FIG. 2D can be performed by a VA platform/system, such as the VA platform 204 or the system 250. In some embodiments, one or more process blocks of FIG. 2D may be performed by another device or a group of devices separate from or including the VA platform 204 or the system 250, such as a user device 202 or a network 206.

At 290a, the method can include obtaining information relating to a context associated with a user. For example, the VA platform 204 or the system 250 can obtain information relating to a context associated with a user in a manner similar to that described above with respect to FIG. 2A or FIG. 2B.

At 290b, the method can include monitoring, based on the obtaining the information, a behavior of the user relative to the context. For example, the VA platform 204 or the system 250 can monitor, based on the obtaining the information, a behavior of the user relative to the context in a manner similar to that described above with respect to FIG. 2A or FIG. 2B.

At 290c, the method can include determining to provide assistance to the user based on the monitoring the behavior of the user. For example, the VA platform 204 or the system 250 can determine to provide assistance to the user based on the monitoring the behavior of the user in a manner similar to that described above with respect to FIG. 2A or FIG. 2B.

At 290d, the method can include responsive to the determining to provide assistance to the user, identifying an assistive action, wherein the identifying the assistive action is based on a predefined threshold. For example, the VA platform 204 or the system 250 can, responsive to the determining to provide assistance to the user, identify an assistive action in a manner similar to that described above with respect to FIG. 2A or FIG. 2B, where the identifying the assistive action is based on a predefined threshold.

At 290e, the method can include, based on the identifying the assistive action, performing the assistive action for the user. For example, the VA platform 204 or the system 250 can, based on the identifying the assistive action, perform the assistive action for the user in a manner similar to that described above with respect to FIG. 2A or FIG. 2B.

In various embodiments, the information may comprise data regarding a location of the user, calendar data associated with the user, travel data associated with the user, a present time of day, local weather data, data regarding a presence of one or more individuals or objects proximate to the user, data regarding communications associated with the user, or a combination thereof.

In some embodiments, the monitoring the behavior of the user relative to the context may be based on data provided by a camera device, an audio input device, or a combination thereof. In certain embodiments, the monitoring the behavior of the user relative to the context may comprise monitoring for user inaction to external stimuli, monitoring biometric data associated with the user, or a combination thereof. In one or more embodiments, the monitoring the behavior of the user relative to the context may comprise detecting whether the user is likely distracted, frustrated, stressed, or a combination thereof.

In one embodiment, the predefined threshold may relate to a user preference, historical behavior associated with the user, or a combination thereof. In various embodiments, the predefined threshold may relate to a distance restriction, a time-based restriction, a schedule-based restriction, a cost-related restriction, a medical condition associated with the user, or a combination thereof. In some embodiments, the predefined threshold may be based on a determined contextual norm.

In certain embodiments, the performing the assistive action for the user may comprise causing one or more recommendations or options to be presented to the user. In one or more embodiments, the performing the assistive action for the user may comprise communicating with an external system to conduct a transaction for the user, to identify a travel route for the user, to plan an itinerary for the user, or a combination thereof.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2E depicts an illustrative embodiment of a method 295 in accordance with various aspects described herein. In some embodiments, one or more process blocks of FIG. 2E can be performed by a VA platform/system, such as the VA platform 204 or the system 250. In some embodiments, one or more process blocks of FIG. 2E may be performed by another device or a group of devices separate from or including the VA platform 204 or the system 250, such as a user device 202 or a network 206.

At 295a, the method can include obtaining information that is associated with a particular contact. For example, the VA platform 204 or the system 250 can obtain information that is associated with a particular contact in a manner similar to that described above with respect to FIG. 2A or FIG. 2B.

At 295b, the method can include detecting that a user is engaged in a communication session with the particular contact. For example, the VA platform 204 or the system 250 can detect that a user is engaged in a communication session with the particular contact in a manner similar to that described above with respect to FIG. 2A or FIG. 2B.

At 295c, the method can include, responsive to the detecting that the user is engaged in the communication session with the particular contact, monitoring a behavior of the user during the communication session. For example, the VA platform 204 or the system 250 can, responsive to the detecting that the user is engaged in the communication session with the particular contact, monitor a behavior of the user during the communication session in a manner similar to that described above with respect to FIG. 2A or FIG. 2B.

At 295d, the method can include determining, from the monitoring the behavior of the user during the communication session, a need to provide assistance to the user. For example, the VA platform 204 or the system 250 can determine, from the monitoring the behavior of the user during the communication session, a need to provide assistance to the user in a manner similar to that described above with respect to FIG. 2A or FIG. 2B.

At 295e, the method can include, responsive to the determining the need to provide assistance to the user, causing a recommendation to be presented to the user, wherein the recommendation relates to the information that is associated with the particular contact. For example, the VA platform 204 or the system 250 can, responsive to the determining the need to provide assistance to the user, cause a recommendation to be presented to the user in a manner similar to that described above with respect to FIG. 2A or FIG. 2B, where the recommendation relates to the information that is associated with the particular contact.

In one or more embodiments, the communication session may comprise a conversation or a dialogue. In various embodiments, the determining the need to provide assistance to the user may be based on detecting non-responsiveness of the user during the communication session. In some embodiments, the determining the need to provide assistance to the user may be based on detecting a voice-based command from the user for assistance, a gesture-based command from the user for assistance, or a combination thereof.

In certain embodiments, the causing the recommendation to be presented to the user may comprise causing the recommendation to be presented audibly, visually via an augmented reality (AR) object or marker, or a combination thereof.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

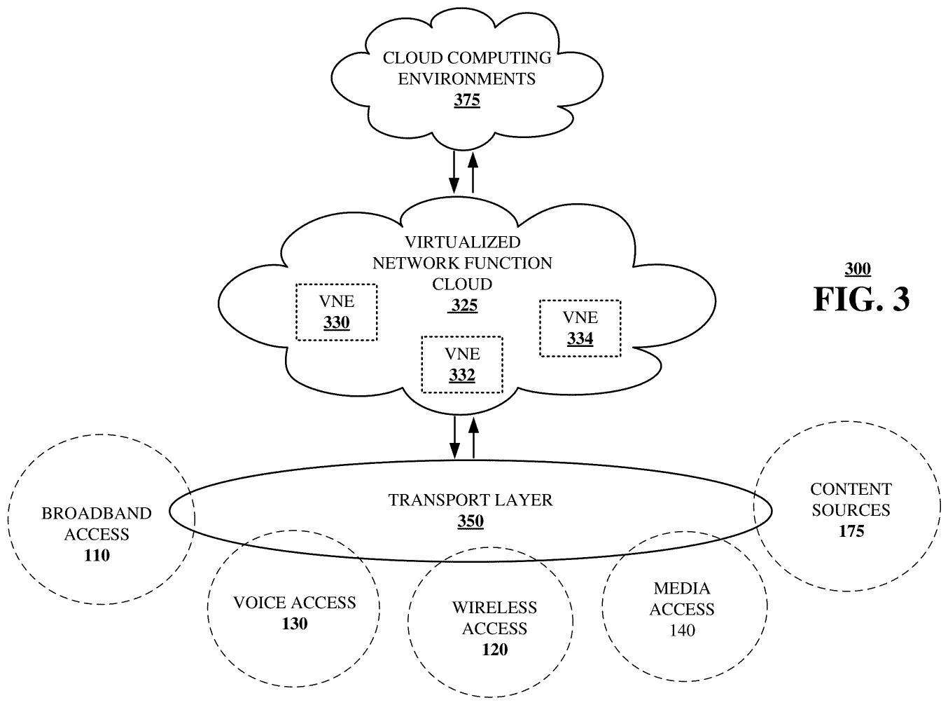

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of systems 100, 200, and/or 250 and methods 290 and/or 295 presented in FIGS. 1, 2A, 2B, 2D, and 2E. For example, virtualized communications network 300 can facilitate, in whole or in part, monitoring of the behavior of a user and/or contextual (or situational) information relating to the user, determining a need to provide assistance to the user based on the monitoring, and performing one or more assistive actions for the user.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

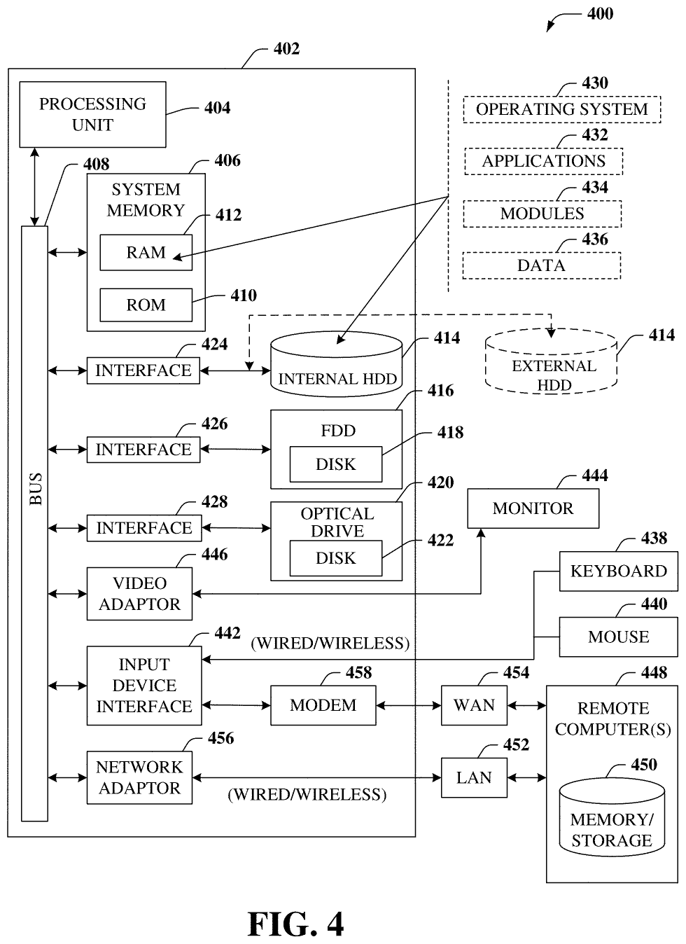

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, monitoring of the behavior of a user and/or contextual (or situational) information relating to the user, determining a need to provide assistance to the user based on the monitoring, and performing one or more assistive actions for the user.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

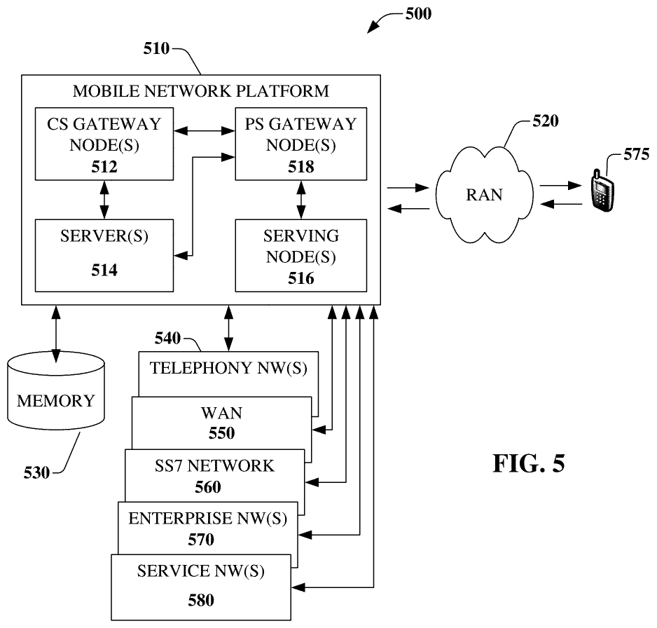

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, monitoring of the behavior of a user and/or contextual (or situational) information relating to the user, determining a need to provide assistance to the user based on the monitoring, and performing one or more assistive actions for the user. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

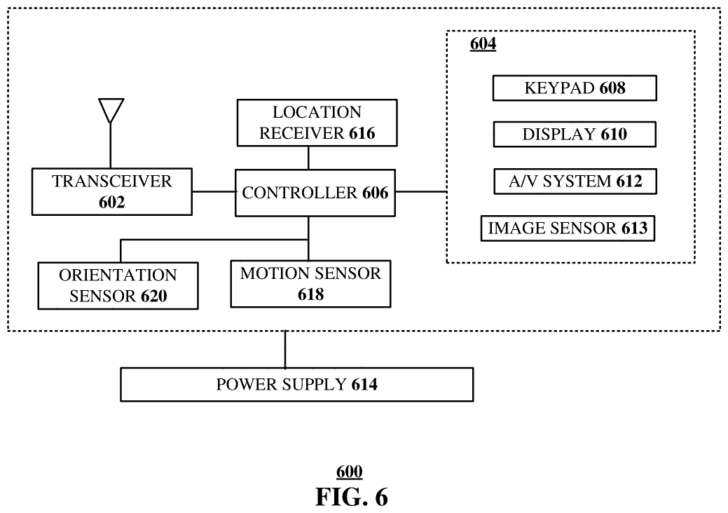

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate, in whole or in part, monitoring of the behavior of a user and/or contextual (or situational) information relating to the user, determining a need to provide assistance to the user based on the monitoring, and performing one or more assistive actions for the user.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining information relating to a context associated with a user;
monitoring, based on the obtaining the information, a behavior of the user relative to the context;
determining to provide assistance to the user based on the monitoring the behavior of the user;
responsive to the determining to provide assistance to the user, identifying an assistive action, wherein the identifying the assistive action is based on a predefined threshold; and
based on the identifying the assistive action, performing the assistive action for the user.

2. The device of claim 1, wherein the information comprises data regarding a location of the user, calendar data associated with the user, travel data associated with the user, a present time of day, local weather data, data regarding a presence of one or more individuals or objects proximate to the user, data regarding communications associated with the user, or a combination thereof.

3. The device of claim 1, wherein the monitoring the behavior of the user relative to the context is based on data provided by a camera device, an audio input device, or a combination thereof.

4. The device of claim 1, wherein the monitoring the behavior of the user relative to the context comprises monitoring for user inaction to external stimuli, monitoring biometric data associated with the user, or a combination thereof, and wherein the operations further comprise identifying a change to the context based on identifying a presence of another user or individual.

5. The device of claim 1, wherein the monitoring the behavior of the user relative to the context comprises detecting whether the user is likely distracted, frustrated, stressed, or a combination thereof.

6. The device of claim 1, wherein the predefined threshold relates to a user preference, historical behavior associated with the user, or a combination thereof.

7. The device of claim 1, wherein the predefined threshold relates to a distance restriction, a time-based restriction, a schedule-based restriction, a cost-related restriction, a medical condition associated with the user, or a combination thereof.

8. The device of claim 1, wherein the predefined threshold is based on a determined contextual norm.

9. The device of claim 1, wherein the performing the assistive action for the user comprises causing one or more recommendations or options to be presented to the user.

10. The device of claim 1, wherein the performing the assistive action for the user comprises communicating with an external system to conduct a transaction for the user, to identify a travel route for the user, to plan an itinerary for the user, or a combination thereof.

11. A non-transitory machine-readable medium, comprising executable instructions that, when executed by a processing system including a processor, facilitate performance of operations, the operations comprising:
obtaining information that is associated with a particular contact;
detecting that a user is engaged in a communication session with the particular contact;
responsive to the detecting that the user is engaged in the communication session with the particular contact, monitoring a behavior of the user during the communication session;
determining, from the monitoring the behavior of the user during the communication session, a need to provide assistance to the user; and
responsive to the determining the need to provide assistance to the user, causing a recommendation to be presented to the user, wherein the recommendation relates to the information that is associated with the particular contact.

12. The non-transitory machine-readable medium of claim 11, wherein the determining the need to provide assistance to the user is based on detecting non-responsiveness of the user during the communication session.

13. The non-transitory machine-readable medium of claim 11, wherein the determining the need to provide assistance to the user is based on detecting a voice-based command from the user for assistance, a gesture-based command from the user for assistance, or a combination thereof.

14. The non-transitory machine-readable medium of claim 11, wherein the causing the recommendation to be presented to the user comprises causing the recommendation to be presented audibly, visually via an augmented reality (AR) object or marker, or a combination thereof.

15. The non-transitory machine-readable medium of claim 11, wherein the communication session comprises a conversation or a dialogue.

16. A method, comprising:
receiving, by a processing system including a processor, information relating to a context associated with a user;
monitoring, by the processing system, and based on the receiving the information, a behavior of the user relative to the context;
detecting, by the processing system, and based on the monitoring the behavior of the user, that the user is likely deviating from a contextual norm determined to be relevant in the context;
identifying, by the processing system, a plurality of recommendations or options responsive to the detecting that the user is likely deviating from the contextual norm; and
based on the identifying the plurality of recommendations or options, causing, by the processing system, the plurality of recommendations or options to be presented to the user to assist the user in the context.

17. The method of claim 16, wherein the context relates to a hospitality setting, wherein the contextual norm relates to transactions for products, services, or a combination thereof associated with the hospitality setting, and wherein the plurality of recommendations or options relates to the products, the services, or the combination thereof associated with the hospitality setting.

18. The method of claim 16, wherein the identifying the plurality of recommendations or options is based on user profile data, user preferences, historical behavior data associated with the user, or a combination thereof.

19. The method of claim 16, further comprising obtaining, by the processing system, feedback from the user regarding the plurality of recommendations or options, identifying, by the processing system, a second plurality of recommendations or options based on the obtaining the feedback, and causing, by the processing system, the second plurality of recommendations or options to be presented to the user to further assist the user in the context.

20. The method of claim 19, further comprising performing a follow-up action to update a user profile associated with the user based on the obtaining the feedback.
